(19) United States
(12) Patent Application Publication
(10) Pub. No.: US 2010/0167976 A1
(43) Pub. Date: Jul. 1, 2010

(54) Composition

(75) Inventors: Fabio Costiniti, Mira (IT); Nassimo Pavan, Mira (IT)

Correspondence Address: PARFOMAK, ANDREW N.;NORRIS MCLAUGHLIN & MARCUS PA, 875 THIRD AVE, 8TH FLOOR, NEW YORK, NY, 10022, US

(73) Assignee: Reckitt Benckiser N.V., Hoofddorp (NL)

(21) Appl. No.: 12/444,612

(22) PCT Filed: Oct. 12, 2007
(86) PCT No.: PCT/GB07/03846

§ 371 Date: Jan. 4, 2010

(30) Foreign Application Priority Data
Oct. 14, 2006 (GB) 0620435.8
Jun. 14, 2007 (GB) 0711414.3

(51) Int. Cl. C02F 5/10

(52) U.S. Cl. 510/253; 252/180

(57) ABSTRACT

A solid zeolite free soluble water softening composition comprises an effervescent system including an organic acid and an alkali which react together upon dissolution in water.

This invention relates to a solid zeolite free soluble water softening composition.

It is well known that certain metal compounds, notably calcium compounds, when present in water, have a significant effect on the properties of the water. For example, “hard” water containing a significant loading of soluble calcium and magnesium compounds may require a large amount of soap or detergent in order to form a lather. Scale deposits can readily form from such water, for example on heating or pH change or evaporation. These can be incrustations, which are left on a surface that has come into contact with the hard water. Particular issues arise in ware washing machines, such as dish and clothes washing machines. In particular scale incrustations may be left on the surfaces of the machines as well as the items washed therein. In particular issues arise with incrustation of heating elements, which reduced their life span and efficiency. A further issue arises in that scale incrustation can be found on the surface of clothes washed in the clothes washing machines which are perceptible to the wearer as feeling harsh to the touch.

There have been many proposals for removal of metal ions from aqueous solutions. In the industrial context proposals have included filter beds and polymeric filters for capturing heavy metal ions from an aqueous solution flowing within a passageway. Examples are given in EP992238A and GB20869564A. In the domestic context chelating compositions can be added to an aqueous washing solution and these can capture metal ions, such as calcium ions. Examples of chelating compositions are given in EP892040A.

Typically in ware washing machines cleaning compositions are provided which are “built” which provide a water softening effect and an increase to the efficiency of the detergent used therein. However, such compositions are not effective for softening the water in the rinse cycle of ware washing machines since such compositions are pumped out of the machine along with the dirty water prior to the rinse cycle. Therefore, scale deposits may build up on the hard surfaces of the washing machine such as the heating element, as well as the fabric of the items being worked.

We have previously found (WO 3080918) that by providing a water-softening agent to the rinse cycle of a ware-washing machine significant benefits can be found, such as reduction in the amount of incrustation and/or water marks caused during the rinse cycle. In addition we have found benefits on the softness of the fabrics after the wash, a reduction in the degree of shrinkage of the fabrics and a reduction in the amount of wrinkles found on the fabrics after the wash.

Typically, such compositions contain sufficient acidity that they neutralise the alkaline residues from the main wash cycle only. In addition, the Ca²⁺ chelating, ability of the composition typically is to build the Ca²⁻ found in the rinse water.

According to a first aspect of the present invention there is provided a solid zeolite free soluble water softening composition comprising an effervescent system including an organic acid and an alkali which react together upon dissolution in water.

By zeolite free it is intended that the composition shall be largely free of zeolites although a small concentration of zeolite can be tolerated. The concentration of zeolite is generally less than 1% and most preferably less than 0.5%.

The composition is advantageous in that it is translucent and therefore has desirable properties for a consumer. Additionally it has been found hat this composition is able to emulate the water softening properties of a composition containing zeolite but without any of the disadvantages associated therewith, such as the problems caused by deposition of the zeolite (zeolite containing/caused limescale) both within a ware-washing machine, such as on the heating element and also upon the laundry being cleaned in the ware-washing machine.

Additionally the composition displays surprisingly high efficacy in providing a water softening function, so much so that only a small amount of the composition is required (in comparison to zeolite based alternatives).

Usually the composition will be used for providing a water softening function in a ware washing (principally a clothes wash) machine. Hence according to a second aspect of the invention there is provided a method of removing and preventing the deposit of limescale in a clothes washing machine by providing a composition comprising a solid zeolite free soluble water softening composition comprising an effervescent system including an organic acid and an alkali which react together upon dissolution in water.

The acid is present in an amount of up to 20%, more preferably up to 15%, more preferably up to 10%, more preferably up to 7%, and most preferably around 5%. The acid is present in an amount of more than 1%, more preferably more than 2%, more preferably more than 3%, more preferably more than 4%, and most preferably around 5%.

Suitable acids are citric, phosphoric, sulphamic, acetic, formic, glycolic and oxalic acid. Preferably the acid is citric acid. (The water softening agent may also act as an acid—examples of such “acidic” water softening agents include polycarboxylate polymers (see below)).

The alkali is present in an amount of up to 20%, more preferably up to 15%, and most preferably around 10%. The alkali is present in an amount of more than 1%, more preferably more than 3%, more preferably more than 5%, more preferably more than 7%, and most preferably around 10%.

The alkali is preferably a sodium/potassium carbonate/salt of a carboxylic acid such as sodium bicarbonate. Sodium silicate may be used as an alkali, either in addition to or as an alternative to the carbonate/salt of a carboxylic acid. Where present the sodium silicate may be present in an amount of 1-3%.

Generally the composition has a pH of (at 1% solution) of from 5.5 to 9.5, more preferably 6 (+/−0.5).

Preferably the composition is substantially free from any fabric softening actives, surfactant, and/or bleach. By substantially free we mean <15% wt, <12% wt, <10% wt, <8% wt, <6% wt, <4% wt, <2% wt, <1% wt, <0.5% wt, <0.1% wt, <0.01% wt of each and any combination or all of the ingredients listed above.

The composition may contain one or more detergent adjuncts such as dye transfer inhibitor, enzyme, optical brightener, soil suspending agent.

The composition may be prepared in a spray-drying process. Such a process can be used to give a low density powder which has a low water content.

Water Softening Agent

Ideally, a water softening agent is also present. Preferred amounts present are from 5 to 80% wt.

There are two main types of method of action for water-softening agents, described below.

1) Ion capture agents—agents which prevent metal ions from forming insoluble salts or reacting with surfactants, such as polyphosphate, monomeric polycarboxylates, such as citric acid or salts thereof, polycarboxylate polymers, such as polyacrylates, acrylic/maleic copolymers, and acrylic phosphonates, EDTA, algins, alginates.

2) Anti-nucleating agents—agents that prevent seed crystal growth, such as polycarboxylate polymers, such as polyacrylates, acrylic/maleic copolymers, and acrylic phosphonates, and sulfonates. Such polymers may also act as ion capture agents as well.

Preferred organic water-soluble water softening agents which may be present include polycarboxylate polymers, such as polyacrylates, acrylic/maleic copolymers, and acrylic phosphonates, monomeric polycarboxylates such as citrates, gluconates, oxydisuccinates, glycerol mono- di- and trisuccinates, carboxymethyloxysuccinates, carboxymethyloxymalonates, dipicolinates, hydroxyethyliminodiacetates, phosphonates, iminodisuccinates, polyaspartic acids, BHT, phosphonate stabilisers such as, diethylenetriaminepenta (methylene phosphonic acid and its corresponding pentasodium salt) available under the trade names Dequest 2060 and Dequest 2066 Monsanto Chemical Co), DTPMP and DTPMA (Dequest 2010) and HEDP.

Preferably the water-soluble water softening agent is a neutralised or partially neutralised carboxylic acid, such as citric acid, succinic acid or maleic acid, and/or a neutralised or partially neutralised polycarboxylic acid, such as a polyacrylate of Mw: 4000-8000 (such as Acusol 445N (Rohm & Haas) CAS REG Nr. 66019-18-9 or Sokalan from BASF).

The invention will now be described, by way of embodiment, with reference to the following example.

### EXAMPLE 1

Formulations were prepared as below.

Formulation 1

| Component | Weight % |
|---|---|
| citric acid | 5.00 |
| Tri-Sodium Citrate | 33.73 |
| Acrylic Homopolymer (granular) | 19.51 |
| Sodium bicarbonate | 10.00 |
| Sodium Sulphate light | 30.10 |
| Bentonite/HEDP speckles | 0.50 |
| Polyethylene Glycol | 0.50 |
| Na xylene sulfonate powder | 0.30 |

Formulation 2

| Component | Weight % |
|---|---|
| citric acid | 5.00 |
| Tri-Sodium Citrate | 33.27 |
| Acrylic Homopolymer (granular) | 18.40 |
| Sodium bicarbonate | 9.50 |
| Sodium Sulphate light | 24.41 |
| Bentonite/HEDP speckles | 0.50 |
| Na xylene sulfonate powder | 1.00 |
| Optical brightener (FWA) SWN | 0.15 |
| Optical brightener (FWA) CBSX | 0.13 |
| Optical brightener (FWA) DMS | 0.43 |
| Copolymer | 1.08 |
| Sodium silicate | 1.08 |
| Cellulase | 0.15 |
| PVP | 1.00 |
| CMC | 2.52 |
| Non-ionic surfactant | 0.30 |
| Water and minors | 1.08 |

Formulation 3

| Component | Weight % |
|---|---|
| citric acid | 5.00 |
| Tri-Sodium Citrate | 33.27 |
| Acrylic Homopolymer (granular) | 18.40 |
| Sodium bicarbonate | 9.50 |
| Sodium Sulphate light | 25.34 |
| Bentonite/HEDP speckles | 0.50 |
| Na xylene sulfonate powder | 1.00 |
| Copolymer | 1.10 |
| Sodium silicate | 1.10 |
| PVP | 1.00 |
| CMC | 0.70 |
| Non-ionic surfactant | 0.16 |
| Water and minors | 2.93 |

Formulation 4

| Component | Weight % |
|---|---|
| Acrylic Homopolymer | 19.52 |
| Sodium Citrate | 33.28 |
| Citric Acid | 5.00 |
| Sodium Sulphate | 24.51 |
| Polyethylene Glycol 200 | 0.50 |
| Sodium Bicarbonate | 10.00 |
| Na xylene sulfonate powder | 0.30 |
| Bentonite/HEDP speckles | 0.50 |
| CMC | 3.60 |
| PVP | 1.00 |
| Cellulase 0.7 | 1.80 |

Formulation 5

| Component | Weight % |
|---|---|
| citric acid | 5.00 |
| Tri-Sodium Citrate | 33.28 |
| Acrylic Homopolymer granular | 19.51 |
| Sodium bicarbonate | 9.50 |
| Sodium Sulphate light | 25.63 |
| Bentonite/HEDP speckles | 0.50 |
| Polyethylene Glycol | 0.30 |
| Na xylene sulfonate powder | 1.00 |
| PVP | 1.00 |
| CMC | 3.60 |
| Cellulase 0.7 | 1.80 |

Formulation 6

| Component | Weight % |
|---|---|
| Spraying Tower | |
| Sodium disilicate | 1.08 |
| Colopymer (acrylate maleate) | 1.08 |
| Sodium Sulphate | 24.02 |
| FWA DMS | 0.43 |
| Post addition | |
| Citric Acid | 5.00 |
| Sodium Citrate | 33.27 |
| Homopolimer (acylic polycarboxylate) | 18.40 |
| Sodium Bicarbonate | 9.50 |
| Bentonite Blue Speckles | 1.00 |
| Na Xylene Sulfonate | 1.00 |
| FWA AC (SWN) | 0.04 |
| FWA CBSX | 0.13 |
| Cellulase 0.7 | 0.15 |
| PVP | 1.00 |
| CMC | 2.52 |
| Non ionic | 0.30 |
| Water and minors | 1.08 |

The formulations showed excellent translucency and water softening performance when used in a ware washing machine.

1. A solid, zeolite free soluble water softening composition comprising an effervescent system including an organic acid and an alkali which react together upon dissolution in water.

2. A composition according to claim 1, wherein the acid is present in an amount of at least about 5%.

3. A composition according to claim 2, wherein the organic acid is selected from the group consisting of: citric, phosphoric, sulphamic, acetic, formic, glycolic and oxalic acid.

4. A composition according to claim 1 wherein the alkali is present in an amount of at least about 10%.

5. A composition according to claim 1, wherein the composition has a pH of (at 1% solution) of 5.5. to 9.5.

6. A method of removing and preventing the deposit of limescale in a clothes washing machine comprising the step of:
providing a composition comprising a solid zeolite free soluble water softening composition which comprises an effervescent system including an organic acid and an alkali which react together upon dissolution in water to the clothes washing machine.

7. A method according to claim 6, wherein the composition additionally comprises a water-softening agent selected from an ion exchange agent, and ion capture agent or an anti-nucleating agent, or a mixture thereof.

8. A method according to claim 6, wherein the composition is added into the fabric softening dispensing drawer of a clothes washing machine.

9. A composition according to claim 2, wherein the alkali is present in an amount of at least about 10%.

10. A composition according to claim 3, wherein the alkali is present in an amount of at least about 10%.

11. A composition according to claim 2, wherein the composition has a pH of (at 1% solution) of 5.5. to 9.5.

12. A composition according to claim 3, wherein the composition has a pH of (at 1% solution) of 5.5. to 9.5.

13. A composition according to claim 4, wherein the composition has a pH of (at 1% solution) of 5.5. to 9.5.
